(19) United States
(12) Patent Application Publication
(10) Pub. No.: US 2018/0246960 A1
(43) Pub. Date: Aug. 30, 2018

(54) Enabling user to post, search, verify & view user selected & created structured fields specific contents related to products & services

(71) Applicant: Yogesh Rathod, Mumbai (IN)

(72) Inventor: Yogesh Rathod, Mumbai (IN)

(21) Appl. No.: 15/420,117

(22) Filed: Jan. 31, 2017

(51) Int. Cl. G06F 17/30; G06Q 30/02

(52) U.S. Cl. CPC G06F 17/30722; G06F 17/30705; G06Q 30/0282

(57) ABSTRACT

Various embodiments of a system and methods for enabling user to post, search, verify, validate, check, compare, analyze, request & view user selected, requested & created structured fields specific contents related to products & services

### FIELD OF INVENTION

The present invention relates generally to enabling user(s) to enabling user to post, search, verify & view user selected or created or updated structured fields specific contents related to products & services.

### BACKGROUND OF THE INVENTION

At present plurality types of products & services review web sites and applications provide product or service or category specific user reviews, comments & ratings.

None of the said review web sites & applications enabling user(s) to enabling user to post, search, verify & view user selected, created & updated structured fields specific contents related to products & services.

Therefore, it is with respect to these considerations and others that the present invention has been made.

### OBJECT OF THE INVENTION

The principal object of the present invention is to enabling user(s) to enabling user to post, search, verify & view user created or selected or updated structured fields specific contents related to one or more keywords, key phrases, categories, taxonomies, items, nodes, lists, named entities including products or services or brand name, web sites, applications, device, item, things, person, group, movie, music, book, shop, real estate, road, company or business names, locations or place, activities, actions, events, transactions.

The other object of the present invention is to post or share user selected or created or updated structured fields or forms or applications or interfaces or set of controls specific one or more types of contents related to one or more keywords, key phrases, categories, taxonomies, items, nodes, lists, named entities including products or services or brand name, web sites, applications, device, item, things, person, group, movie, music, book, shop, real estate, road, company or business names, locations or place, activities, actions, events, transactions.

The other object of the present invention is to search, match, browse, select, receive & view request or preferences or SQL query or search query specific user posted structured field(s) specific one or more types of contents related to one or more keywords, key phrases, categories, taxonomies, items, nodes, lists, named entities including products or services or brand name, web sites, applications, device, item, things, person, group, movie, music, book, shop, real estate, road, company or business names, locations or place, activities, actions, events, transactions.

The other object of the present invention is to present selected product or service specific user provided parameters & structured fields specific verified reports, structured fields specific contents, comparative analysis, multi-dimensional analysis, aggregated & calculated statistics, contextual alternatives or suggested or advertised or sponsored or affiliated or matched products & services, contextual actual customers and/or experts for real-time conversations and contextual user actions.

### DETAIL DESCRIPTION OF THE PREFERRED EMBODIMENT

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the term “receiving” posted or shared contents & communication and any types of multimedia contents from a device or component includes receiving the shared or posted contents & communication and any types of multimedia contents indirectly, such as when forwarded by one or more other devices or components. Similarly, “sending” shared contents & communication and any types of multimedia contents to a device or component includes sending the shared contents & communication and any types of multimedia contents indirectly, such as when forwarded by one or more other devices or components.

As used herein, the term “client application” refers to an application that runs on a client computing device. A client application may be written in one or more of a variety of languages, such as ‘C’, ‘C++’, ‘C#’, ‘J2ME’, Java, ASP.Net, VB.Net and the like. Browsers, email clients, text messaging clients, calendars, and games are examples of client applications. A mobile client application refers to a client application that runs on a mobile device.

As used herein, the term “network application” refers to a computer-based application that communicates, directly or indirectly, with at least one other component across a network. Web sites, email servers, messaging servers, and game servers are examples of network applications.

Briefly stated, the present invention is directed towards enabling user(s) to enabling user to post, search, verify & view user selected or created or updated structured fields specific contents related to products & services.

In one embodiment present invention enabling user to search, match, input, update or select one or more keywords, key phrases, categories, taxonomies, items, nodes, lists, named entities (225); enabling to check, verify, validate, analyze & process said keywords, key phrases, categories, taxonomies, items, nodes, lists, named entities (227); enabling user to search, match, select, create, add, remove, update one or more structured fields (291 & 293) related to said one or more keywords, key phrases, categories, taxonomies, items, nodes, lists, named entities; enabling to check, verify, validate, analyze & process said keywords, key phrases, categories, taxonomies, items, nodes, lists, named entities (227) associate said structured fields (292); enabling user to post (250) one or more types of contents including said one or more structured fields specific contents & values related to said one or more keywords, key phrases, categories, taxonomies, items, nodes, lists, named entities; enabling user to select one or more selected or inputted keywords, key phrases, categories, taxonomies, items, nodes, lists, named entities (415/417) related one or more structured fields and/or select, input, update & provide associate values or ranges (442); and presenting or providing said selected one or more selected or inputted keywords, key phrases, categories, taxonomies, items, nodes, lists, named entities and/or selected one or more selected structured fields and/or associate values or ranges specific one or more types of digital contents (FIGS. 5-7).

In another embodiment verify and/or register users.

In another embodiment verifying users based on submission of one or more types of proof of identities, real-time providing live photos or videos, providing & verifying mobile phone number(s) & email or social network identities, credit card information, storing, monitoring & tracking user ratings.

In another embodiment keywords, key phrases, categories, taxonomies, items, nodes, lists, named entities (225) including products or services or brand name, web sites, applications, device, item, things, person, group, movie, music, book, shop, real estate, road, company or business names, locations or place, activities, actions, events, transactions.

In another embodiment verifying (227) keywords, key phrases, categories, taxonomies, items, nodes, lists, named entities (225) comprises spell or language checking, checking uniqueness, spam or duplicate or similar keywords, key phrases, categories, taxonomies, items, nodes, lists, named entities.

In another embodiment verifying (227) keywords, key phrases, categories, taxonomies, items, nodes, lists, named entities (225) comprises verify via human(s) including administrator(s) and/or web sites or applications and/or service(s) and/or search engine(s) and/or database(s) including thesaurus or dictionaries.

In another embodiment verifying (292) structured fields (293) comprises spell or language checking, checking uniqueness, spam or duplicate or similar structured fields.

In another embodiment verifying (292) structured fields (293) comprises verify via human(s) including administrator(s) and/or web sites or applications and/or service(s) and/or search engine(s) and/or database(s) including thesaurus or dictionaries.

In another embodiment verifying actual customer or buyer or user or viewer or reader or listener or transactor or employee or owner or tourist or guest or visitor or client or student based on submission of one or more types of proof of purchases or subscriptions or payments including digital bills or invoices or transaction details from reliable source(s) or tickets provided by user and/or seller and/or reliable source(s) or database(s).

In another embodiment one or more types of digital contents including one or more types of media including text, structured contents or data, forms, video, audio, voice, photos, images, links, documents, questions and/or answers, blogs, comments, reviews, number of likes, dis-likes, ratings, contacts, user date, user profile, statistics, applications, web sites, web pages, services, interfaces, widgets, objects, controls, user actions, analysis reports & true or checked or user provided or verified or calculated or compiled or expert human mediated or aggregated or comparative or updated values or ranges.

In another embodiment enabling user to follow one or more products & services associate structured fields' specific updated contents posted by users of network.

In another embodiment enabling user to communicate, collaborate & chatting with actual customers or users for one or more one or more keywords, key phrases, categories, taxonomies, items, nodes, lists, named entities including one or more types of products and/or services and/or people.

In another embodiment enabling user to communicate, collaborate & chatting comprises asking questions or queries or search query, send or receive or share messages or contents or one or more types of media, phone or VOIP calling, instant messaging, emailing, meet personally.

In another embodiment adding points to user account based on adding or updating structured fields, posting one or more types of contents or structured fields specific contents, number of posts, provided structured fields, views, provided or received views, likes or dis-likes, ratings, comments, reviews, reports, followers, viewers & contacts or connections, viewing advertised contents, purchasing of products, subscribing services, make payments, refer products or services, participate in activities, downloading applications, registering with web sites, taking one or more actions including providing contact details, detail profile, fill-up forms and like.

In another embodiment deducting points to user account based on number of searches or browsing or viewing, number of times or duration of real-time communicating, collaborating & messaging with actual customers or experts, number of verifications of products or services or people based on number of structured fields, number of requested or requested types of contents including answers of questions, search results, media, directions, map, address, price, comparisons, availability, sources of purchases, suggestions or similar products or services or named entities.

In another embodiment enabling user to select or register one or more types of user services including provide comments, reviews, ratings, likes or dis-lies, reports, share contents, provide structured fields or associate contents, live chat with prospective customers, or users or subscribers, suggest products or services, provide comparison analysis, provide answers of questions, provide expert services, provide search results or data or details, provide customer support, refer or sell or present products & services, list or sell or make available products or services and like.

In another embodiment enabling user to define validation logic of structured fields including type of data of field including text, type of media including image, video & audio, date & time, numeric, flag & ranges, length of field, maximum or minimum values, selection from provided or defined list of values, measurements or type of currency including kilogram, inch, liter & dollar, select or associate one or more type of applications, interfaces, controls & forms including textbox or edit control, combo box, list box, checkbox, radio button, selections, menus, buttons including submit button for user selections & providing structured field specific structured contents.

In another embodiment enabling user to data mine or multi-dimensional analysis or SQL query structured fields specific contents.

In another embodiment enabling user to manually check defined or provided or updated structured fields specific contents provided by other users of network.

In another embodiment presenting selected or inputted products and/or services specific contextual structured fields for selecting & posting or asking or searching or verifying, validating, analyzing, calculating or comparing structured field(s) specific contents.

In another embodiment present selected or inputted products and/or services specific user actions.

In another embodiment user actions comprises download, buy, subscribe, refer, share, add to cart, make purchase enquiry, sent requirement specifications, request or ask for quote, make order, make payment, participate in group deals, book tickets, add to watch or wish list, sent messages to actual customers or sellers, register domains, update or upgrade products or services, sent job profile, invite users, book table, apply for credit card, listen music, view videos, ask for sample, provide contact details or permissions, bookmark or add to one or more types of lists, say buying interest, ask for discount or negotiate, provide bid, purchase based on reviews or comments or reviews or comments of particular user(s), register web site, ask for demonstration or presentation or site seeing & like.

In another embodiment enabling user to add structure field for asking or requesting associate values or contents or data or media for one or more products or services.

In another embodiment enabling user to provide more than one values or sub field(s) and associate value(s) for structure field separated by specific delimiter(s).

In another embodiment enabling user to receive & view preferences specific including one or more keywords, key phrases, categories, taxonomies, items, nodes, lists, named entities including products or services or brand name, web sites, applications, device, item, things, person, group, movie, music, book, shop, real estate, road, company or business names, locations or place, activities, actions, events, transactions associate structured fields specific updated contents posted by users of network.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 is a system diagram of one embodiment of an environment in which the invention may be practiced;

FIG. 2 illustrates exemplary graphical user interface (GUI) for enabling users to post user selected & created structured fields specific contents related to one or more keywords, key phrases, categories, taxonomies, items, nodes, lists, named entities, products & services;

FIG. 3 illustrates exemplary graphical user interface (GUI) for enabling users to search one or more keywords, key phrases, categories, taxonomies, items, nodes, lists, named entities, products & services specific user provided or posted or shared structured fields specific one or more types of contents;

FIG. 4 illustrates exemplary graphical user interface (GUI) for enabling users to provide criteria, preferences, parameters, selected structured fields and/or associate user provided values for verify, validate, analyze buying of particular product or service decision of users;

FIG. 5 illustrates exemplary graphical user interface (GUI) for enabling users to view said user provided criteria, preferences, parameters, selected structured fields and/or associate user provided values specific contents, structured fields specific contextual contents, contextual user actions, contextual & available actual customers and/or experts for conversations, similar products & services, comparative analysis;

FIG. 6 illustrates exemplary graphical user interface (GUI) for enabling users to view said user provided criteria, preferences, parameters, selected structured fields and/or associate user provided values specific concise, aggregated structured fields specific contents, user comments, reviews, ratings, shared contents, measurable structured statistics, comparative analysis, suggested or alternative or similar or affiliated or advertised or matched products & services and contextual user actions;

FIG. 7 illustrates exemplary graphical user interface (GUI) for enabling users to real-time chat, communications, collaborations & messaging with contextual actual customers and/or experts and/or sellers or providers related to user selected products or services or people or keywords;

FIG. 8 illustrates exemplary graphical user interface (GUI) for enabling users to select or provide or set or update one or more user services, wherein user services are services which user willing to provide to other users including add or post structured fields and associate structured contents, real-time converse with prospective buyers, provide comparative analysis & similar products & services, provide answers, shared contextual contents, search results & like;

FIG. 9 illustrates an example computer system suitable for implementing various components of the system and method for posting, searching, verifying, validating, checking, comparing, analyzing, processing, compiling, consolidating & viewing user selected & created structured fields specific contents related to products & services, according to some embodiments.

While the invention is described herein by way of example for several embodiments and illustrative drawings, those skilled in the art will recognize that the invention is not limited to the embodiments or drawings described. It should be understood, that the drawings and detailed description thereto are not intended to limit the invention to the particular form disclosed, but on the contrary, the intention is to cover all modifications, equivalents and alternatives falling within the spirit and scope of the present invention. The headings used herein are for organizational purposes only and are not meant to be used to limit the scope of the description. As used throughout this application, the word “may” is used in a permissive sense (e.g., meaning having the potential to), rather than the mandatory sense (e.g., meaning must). Similarly, the words “include”, “including”, and “includes” mean including, but not limited to.

### DETAILED DESCRIPTION OF THE DRAWINGS

Various embodiments of a system and method for enabling user to post, search, browse, verify, validate, compare, data mine, analyze & view user selected, updated & created structured fields specific user provided contents related to products & services are described. In the following description, numerous specific details are set forth to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

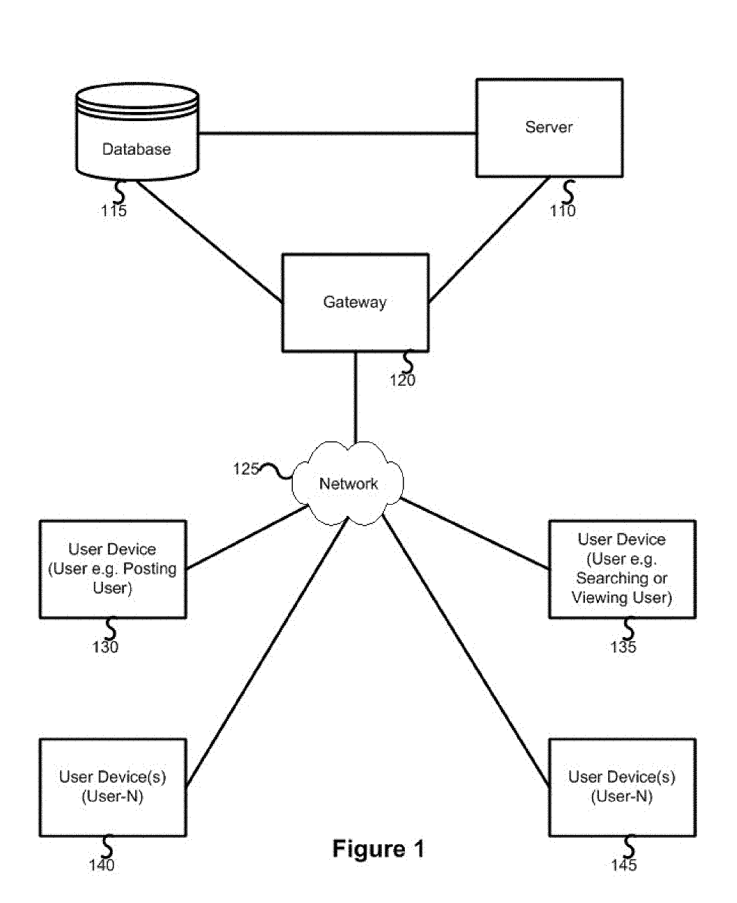

The system for enabling users to select, create, add, update & verify structured fields related to one or more selected, added, updated & verified one or more products and/or services to central repository or database(s) and enabling users to post said selected structured fields specific one or more types of contents and enabling user to search, match, browse, select, compare, analyze, verify & validate buying decision for one or more products and/or services and/or associated one or more structured fields. The system for multi-dimensional manner or mode verifying user's buying decision based on user created & provided structured fields specific contents may be referred to herein, for simplicity, as the “provide, request, view & verify structured fields & associate contents based system.” FIG. 1 illustrates a block diagram of providing, requesting, viewing & verifying structured fields & associate contents based system configured to implement the platform, network, web site, application, server, database, system, method, service, device where posting user(s) 130/140 can select, create, collaboratively add, add based on suggestion, import, verify, validate, add & update structured field(s), configure said structured field(s) including select, set, apply type of data like numeric, text, one or more types of media, validation rules, minimum or maximum values, default values or lists & edit, update, capture, input, select & provide associate metadata & details and provide selected structure field(s) specific one or more type of contents and where searching or viewing or requesting user(s) 135/145 can view, search, match, browse, select & view selected one or more products and/or services specific structured contents and can verify one or more selected products and/or services including verify or ask or request for one or more selected structured fields specific contents, request for comparison analysis, similar or alternative products or services, request for selected types of data or contents or structured contents, request for connect with contextual actual customers and/or experts for communicating, conversing, collaborating & chatting with them.

While FIG. 1 illustrates a gateway 120, a database 115 and a server 110 as separate entities, the illustration is provided for example purposes only and is not meant to limit the configuration of the providing, requesting, viewing & verifying structured fields & associate contents based system. In some embodiments, gateway 120, database 115 and server 110 may be implemented in the providing, requesting, viewing & verifying structured fields & associate contents based system as separate systems, a single system, or any combination of systems.

As illustrated in FIG. 1, the providing, requesting, viewing & verifying structured fields & associate contents based system may include a posting user device or mobile devices 130/140 and viewing user device or mobile devices 135/145. Devices or Mobile devices 130/140/135/145 may be particular set number of or an arbitrary number of devices or mobile devices which may be capable of adding, updating and providing structured fields, preparing, editing, updating & posting or sharing or publishing or advertising or broadcasting or presenting or providing selected structured fields specific one or more types of contents or media or data, searching, matching, selecting, following, browsing & viewing query specific structured contents and verifying products & services based on user provided requests, prospective or actual purchase data, selected structured fields & associate parameters or selections and based on said provided information, system provide contextual, updated & verified information to requestor. Each device or mobile device in the set of posting user(s) 130/140 and viewing or searching or verifying user(s) device or mobile devices 135/145 may be configured to communicate, via a wireless connection, with each one of the other mobile devices 130/140/135/145. Each one of the mobile devices 130/140/135/145 may also be configured to communicate, via a wireless connection, to a network 125, as illustrated in FIG. 1. The wireless connections of mobile devices 130/140/135/145 may be implemented within a wireless network such as a Bluetooth network or a wireless LAN.

As illustrated in FIG. 1, the providing, requesting, viewing & verifying structured fields & associate contents based system may include gateway 120. Gateway 120 may be a web gateway which may be configured to communicate with other entities of the providing, requesting, viewing & verifying structured fields & associate contents based system via wired and/or wireless network connections. As illustrated in FIG. 1, gateway 120 may communicate with mobile devices 130/140/135/145 via network 125. In various embodiments, gateway 120 may be connected to network 125 via a wired and/or wireless network connection. As illustrated in FIG. 1, gateway 120 may be connected to database 115 and server 110 of the providing, requesting, viewing & verifying structured fields & associate contents based system. In various embodiments, gateway 120 may be connected to database 115 and/or server 110 via a wired or a wireless network connection.

Gateway 120 may be configured to send and receive posted or updated structured fields and/or associate contents or posts or data to/from mobile devices 130/140/135/145. For example, gateway 120 may be configured to receive posted or updated structured fields and/or associate contents or posts or data provided by posting users or publishers or content broadcasters to database 115 for storage.

As another example, gateway 120 may be configured to send or present posted or updated structured fields and/or associate contents or posts or data to users or searching users or requestors or followers stored in database 115 to mobile devices 130/140/135/145. Gateway 120 may be configured to receive search requests from mobile devices 130/140/135/145 for searching and presenting posted or updated structured fields and/or associate contents or posts or data.

For example, gateway 120 may receive a request from a mobile device and may query database 115 with the request for searching and matching request specific matched posted or updated structured fields and/or associate contents or posts or data, sources, followers, following users and viewers who are located at request specific place(s) or location(s). Gateway 120 may be configured to inform server 110 of updated data. For example, gateway 120 may be configured to notify server 110 when a new posts or updated structured fields and/or associate contents or posts or data has been received from a mobile device or device of posting or publishing or content broadcaster(s) or provider(s) stored on database 115.

As illustrated in FIG. 1, the providing, requesting, viewing & verifying structured fields & associate contents based system may include a database, such as database 115. Database 115 may be connected to gateway 120 and server 110 via wired and/or wireless connections. Database 115 may be configured to store a database of registered user's profile, accounts, posted or updated structured fields and/or associate contents or posts or data, followed updated products & services, categories & taxonomies, user data, payments information received from mobile devices 130/140/135/145 via network 125 and gateway 120.

Database 115 may also be configured to receive and service requests from gateway 120. For example, database 115 may receive, via gateway 120, a request from a mobile device and may service the request by providing, to gateway 120, user profile, user data, posted or updated structured fields and/or associate contents or posts or data, user or provider account's related data which meet the criteria specified in the request. Database 115 may be configured to communicate with server 110.

As illustrated in FIG. 1, the providing, requesting, viewing & verifying structured fields & associate contents based system may include a server, such as server 110. Server may be connected to database 115 and gateway 120 via wired and/or wireless connections. As described above, server 110 may be notified, by gateway 120, of new or updated user profile, user data, user posted or shared contents, posted or updated structured fields and/or associate contents or posts or data, user followed updated products, services, named entities, people, categories & taxonomies & various types of status stored in database 115.

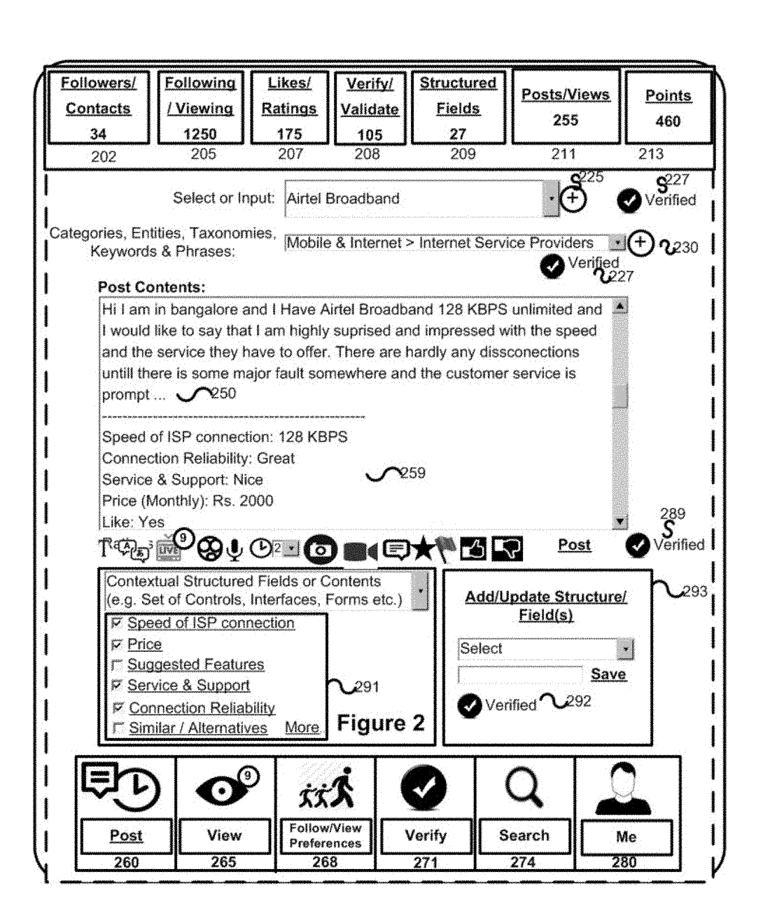

FIG. 2 illustrates exemplary graphical user interface (GUI) for enabling users to post user selected & created structured fields specific contents related to one or more keywords, key phrases, categories, taxonomies, items, nodes, lists, named entities, products & services. User can select one or more products or services 225 or categories, entities, taxonomies, keywords & key phrases 230 or user can input, import, add, update, verify 227 one or more new products or services or named entitles or categories, entities, taxonomies, keywords & key phrases, wherein verification includes verify before add or update to global database 115 of products or services or named entitles. So user and other users of network can select one or more products or services or named entitles for posting contents. Verifying (227) keywords, key phrases, categories, taxonomies, items, nodes, lists, named entities (225) comprises spell or language checking, checking uniqueness, spam or duplicate or similar keywords, key phrases, categories, taxonomies, items, nodes, lists, named entities. User can also enable to search, match, select, create, add, remove, update& verify one or more structured fields (291 & 293) related to said one or more selected keywords, key phrases, categories, taxonomies, items, nodes, lists, named entities 225/230. Verifying (292) structured fields (293) comprises spell or language checking, checking uniqueness, spam or duplicate or similar structured fields. User can post 250 contents and structured fields specific contents 259. After adding or updating or selecting one or more products, services, keywords, key phrases, categories, taxonomies, items, nodes, lists, named entities 225/230, posting user can draft, input, select, import, edit, update, collaboratively update including invited or invitation accepted contacts or users of network, verify & post or share 250 and/or post or share selected structured filed(s) 291 specific one or more types of contents 250/259.

In another embodiment system verifies posted contents including validate structured field specific contents as per validation rules provided by creator of structured fields, check spelling, duplicate contents, copyrighted contents, language of contents, maximum or minimum length of contents and like 289. User can view various statistics and access, manage lists including number & list of followers of users posts related to one or more products & services, contacts & connections 202, following products or services for receiving followed products or services specific posted contents by users of network 205, likes, dis-likes, recommendations, comments & ratings on posted contents by user or provided by user on other users posts 207, verified or validated products or services 208, added structured fields, posts posted y user and associate views or viewership, ratings, comments & likes 255, number of total points including statistics of added or earned or received or purchased or deducted or gift or expense or pay by user and associate logs, activities & details 213.

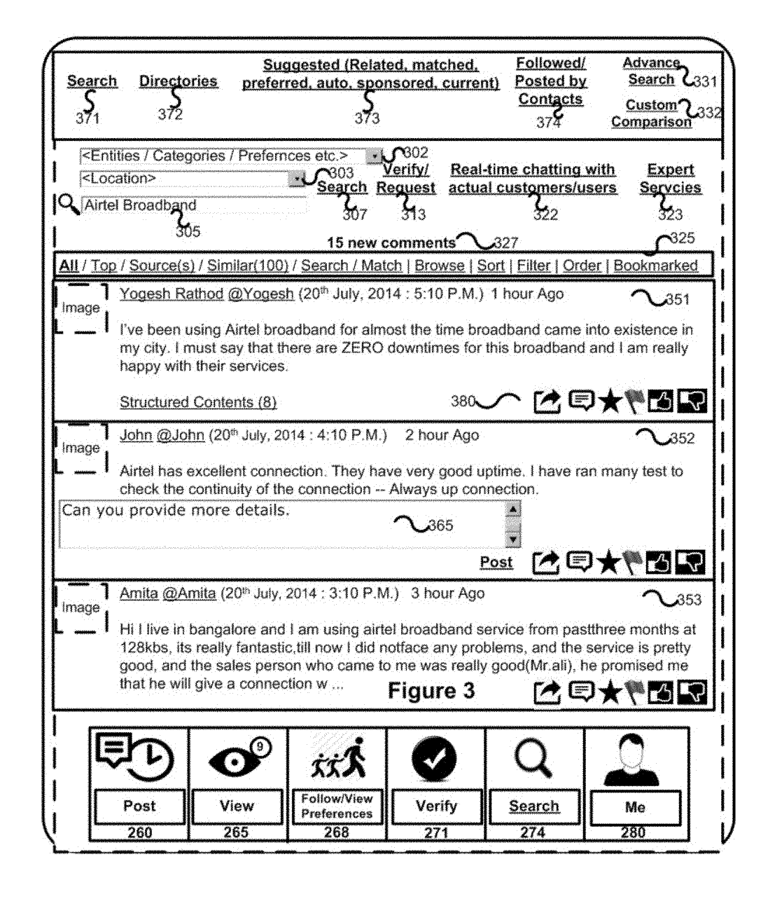

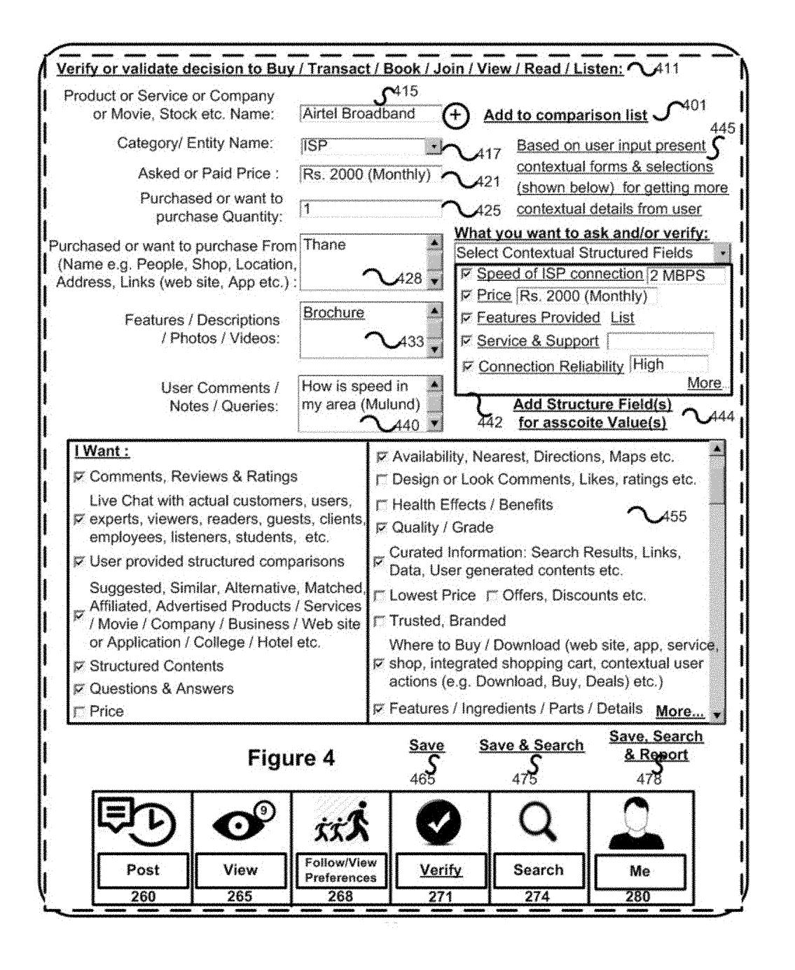

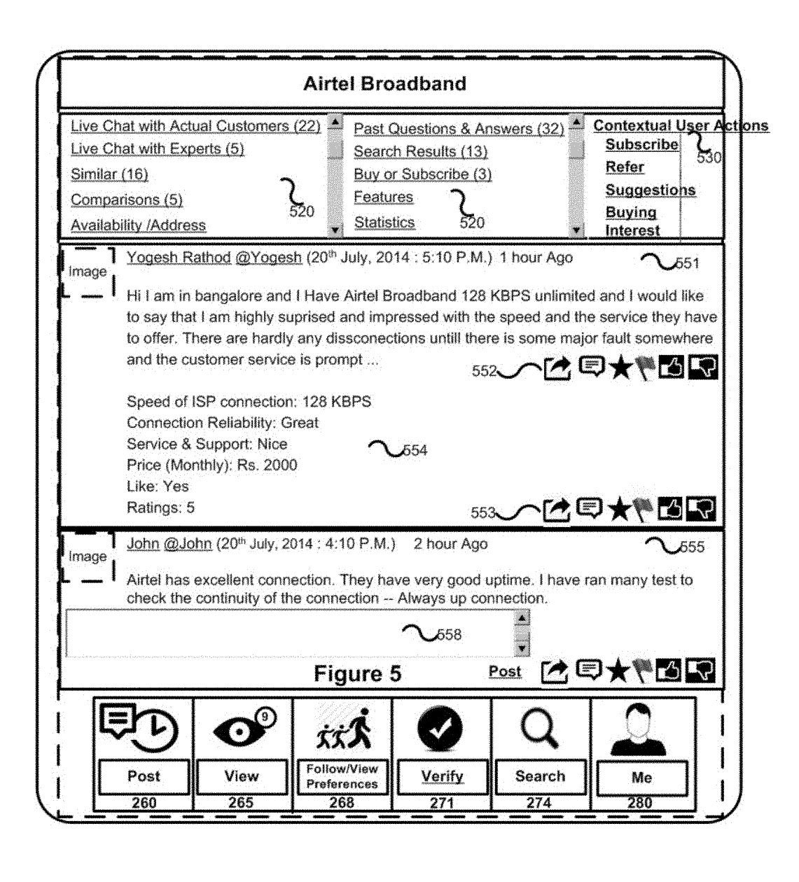

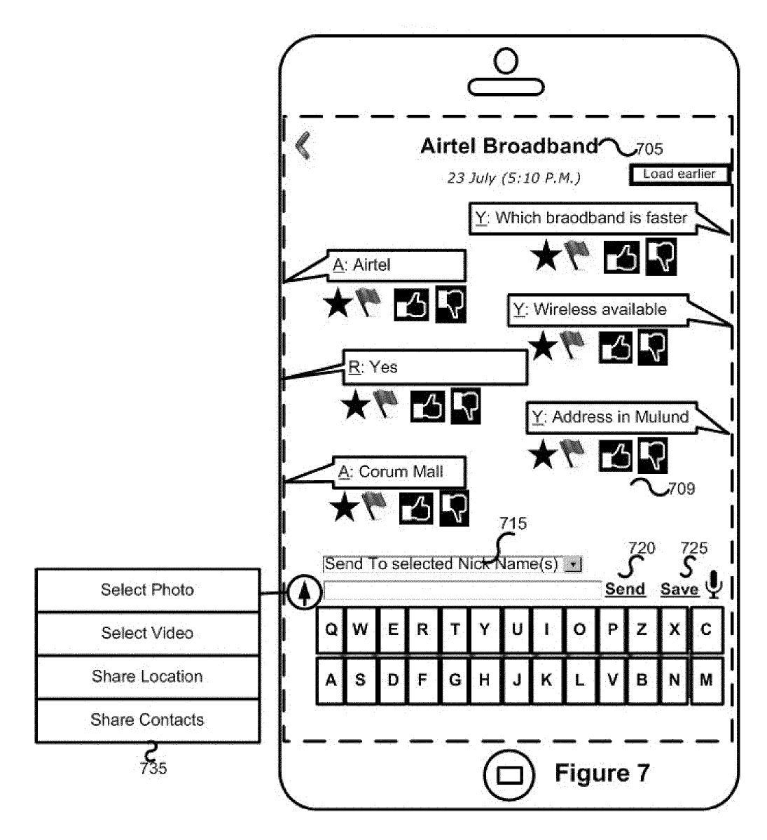

FIG. 3 illustrates exemplary graphical user interface (GUI) for enabling users to search one or more products, services, keywords, key phrases, categories, taxonomies, items, nodes, lists, named entities specific user provided or posted or shared structured fields specific one or more types of contents. FIG. 3 illustrates exemplary graphical user interface (GUI) for enabling users to search 371 one or more products, services, keywords, key phrases, categories, taxonomies, items, nodes, lists, locations, named entities 302/303/305 specific posted contents and/or structured fields specific posted contents by users of network 351/352/353. User is enable to browse directories 372 of or view suggested 373 (based on user profile, user data, preferences, shared contents, connections or contacts, locations, checked-in places, activities & transactions) products, services, keywords, key phrases, categories, taxonomies, items, nodes, lists, named entities for viewing associate posted contents, comments, reviews, ratings, recommendations, user actions and structured fields specific contents. User can view followed products & services specific received updated contents or contents posted by contacts of user 374. User can compare two or more products & services and view associated user created & provided structured fields and/or associate values or contents or data 332. User can select advance search option 331 for providing one or more criteria, conditions, parameters, selected structured fields and/or associate values or contents for searching said provided criteria, preferences & selections specific search results or one or more products or services related structured fields specific structured one or more types of contents or data. User can select verify/request option 313 for verifying, validating, comparing, analyzing, processing, checking, detecting user's buying decision of one or more products or services based on user provided inputs, selections & preferences discussed in detail in FIG. 4-5. User can communicate, collaborate, messaging & chatting with one or more products or services related actual customers or users 322 and/or or experts or sellers or manufacturers or shop keepers or administrators or advertisers or providers 323 for receiving answers of questions, shared contents and converse with them discussed in detail in FIG. 7. User can view new or updated search query or followed or posted by contacts specific contents or structured contents 327. User can search within search, sort, filter, categories, group, list, bookmark, like, dis-like, rate, rank, report, refer share, and provide comments 365 on one or more received or viewed or presented or searched or requested or followed posts 325/380.

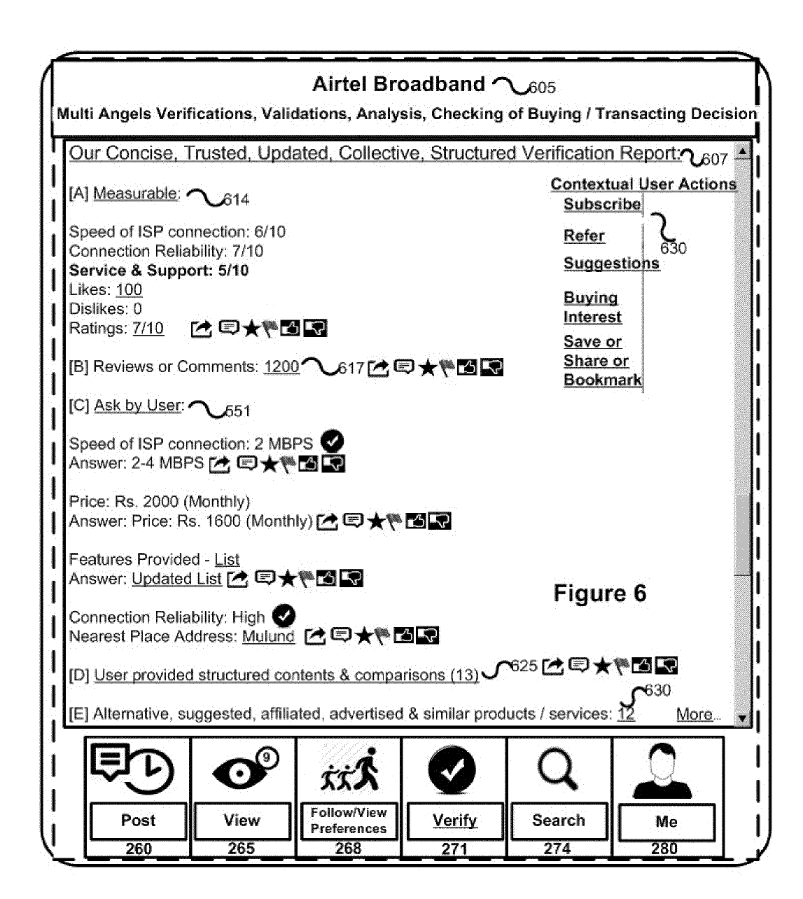

FIG. 4 illustrates exemplary graphical user interface (GUI) for enabling users to provide criteria, preferences, parameters, selected structured fields and/or associate user provided values for verify, validate, compare, process, analyze buying or transacting or viewing or reading or listening or renting or leasing or subscribing or registering or downloading or hiring or applying or booking or joining decision of users related to particular product(s), service(s), named entities including company, bank, movie, song, book & like. User can select one or more entities or categories 417 and select related one or more products and/or services 415 and optionally provide one or more types of details including provide asked or paid price or cost or fees or payments 421, quantity or numbers 425, purchase location or prospective purchase location 428, asked or viewed or know associate features, details, functions, quality 433, user can select from presented said selected product(s) or service(s) specific contextual structured fields and/or provide associate values or ranges or data or contents that user want to verify, validate, compare, analyze 442 and/or add structured fields for receiving associate values or contents or data. User can request one or more selected types of contents, resources, services, applications 455 related to selected products or services 415/417 including comments, reviews & ratings, live chat with actual customers, users, experts, viewers, readers, guests, clients, employees, listeners, students etc., user provided structured comparison analysis, suggested, similar, alternative, matched, affiliated & advertised products, services, movie, company, business, web site, application, college, hotel etc., structured contents, questions & answers, price, availability, nearest, directions, maps etc., product design or look related comments, likes, ratings etc., health effects & benefits, quality & grade, curated information including search results, links, data, user generated contents etc., lowest price, offers, discounts etc., trusted & branded products or services specific, where to buy or download information (e.g. web site, app, service, shop), contextual user actions (e.g. download, buy, deals) etc.), associate features, ingredients, parts & details. User can save 465 said provided preferences (415, 417, 401, 421, 425, 428, 433, 440, 442, 444, and 455) or save & search 475 based on said provided preferences (415, 417, 401, 421, 425, 428, 433, 440, 442, 444, and 455) discussed in detail in FIG. 5 or save, search & verify or validate or checking or analyzing report 478 based on said provided preferences (415, 417, 401, 421, 425, 428, 433, 440, 442, 444, and 455) discussed in detail in FIG. 6.

FIG. 5 illustrates exemplary graphical user interface (GUI) for enabling users to view said user provided criteria, preferences, parameters, selected structured fields and/or associate user provided values specific contents 551, structured fields specific contextual contents 554, contextual user actions 530, contextual & available actual customers and/or experts for conversations, similar products & services, comparative analysis & other requested types of contents 520. User can converse or chat with one or more said contextual & available actual customers and/or experts 520. User can view and access said presented various types of contents including similar services related to “Airtel Broadband”, comparison analysis of internet service providers including “Airtel Broadband” service, availability, address, past curated or rated questions & answers related to “Airtel Broadband” or internet service providers, search results, features, various statistics & sources or links or applications or controls from where or by using that user can buy or subscribe various selected types of “Airtel Broadband” service 520. User can select one or more user actions from presented contextual user actions including subscribe “Airtel Broadband” service, refer “Airtel Broadband” service to one or more contacts, provide suggestions for “Airtel Broadband” service, add “Airtel Broadband” to wish or watch list 530. User can provide like, dislike, rate, rank, comments, report one or more presented posts and/or structured fields specific posts or contents and/or sources of posts or consents or reviews 552, 553. User can sort, filter, order, rank, attach, detach, show, hide, follow, bookmark, mark as useful to buy product or service, add to wish or watch or other type of lists, refer & share one or more selected posts or shared contents and/or structured fields & associate structured contents and/or product or service and/or sources 551, 555.

FIG. 6 illustrates exemplary graphical user interface (GUI) for enabling users to view criteria, conditions, preferences, parameters, selected structured fields and/or associate user provided values specific verified, validated, comparative, processed, analyzed buying or transacting or viewing or reading or listening or renting or leasing or subscribing or registering or downloading or hiring or applying or booking or joining report for enabling user to take or make buying or using decision of users related to said particular product(s), service(s), named entities including company, bank, movie, song, book & like. FIG. 6 illustrates exemplary graphical user interface (GUI) for enabling users to view said user provided criteria, preferences, parameters, selected structured fields and/or associate user provided values specific multi angels verifications, validations, analysis, checking report for making or taking buying or transacting decision related to said particular product or service (e.g. “Airtel Broadband” 605) including various types of statistics or measurable structured statistics 614, user comments, reviews & ratings 617, verified contents & associate details requested or ask by user, concise, aggregated structured fields specific contents, shared contents & comparative analysis 625, suggested or alternative or similar or affiliated or advertised or matched products & services 630 and contextual user actions 630. User can like, dislike, share, report, mark information very useful, useful or not useful or useful to buy product or service and provide ratings & comments to one or more presented contents. User can save, share, sort, filter, show, hide, bookmark, further verify via contextual actual customers and/or experts and/or providers or sellers or administrators, request to update one or more or part of said presented information, contents, media or data and request to provide further information based on updated criteria, conditions, preferences, parameters, selected structured fields and/or associate user provided values.

FIG. 7 illustrates exemplary graphical user interface (GUI) for enabling users to real-time chat, communications, collaborations & messaging 709 with contextual actual customers and/or experts and/or sellers or providers related to user selected products or services or people or keywords 705. Members can send messages, share various types of contents or media 735, ask question or send message(s) to one or more members 715, save chat conversations 725, rate, like, dislike one or more messages or shared contents or members.

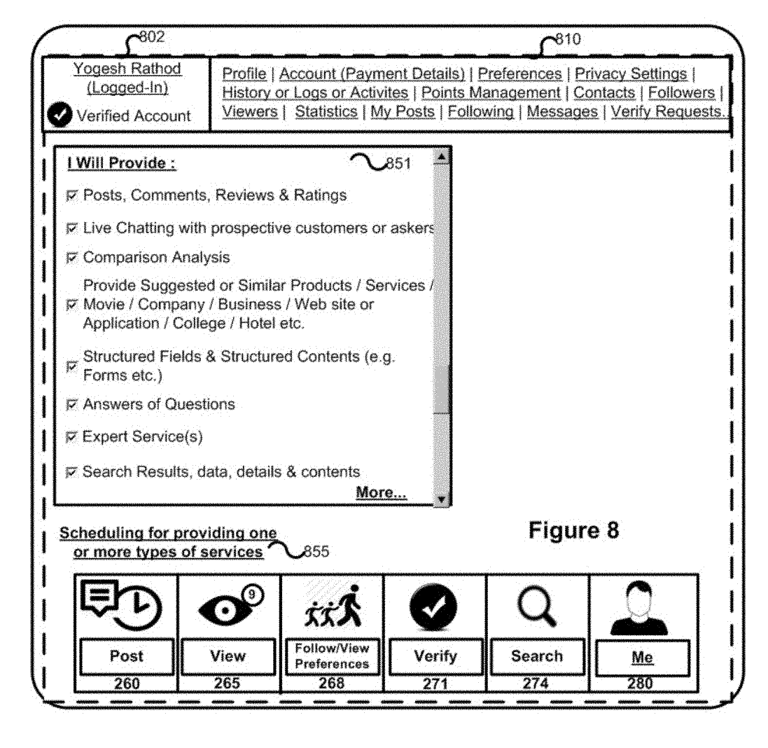

FIG. 8 illustrates exemplary graphical user interface (GUI) for enabling users to select or provide or set or update one or more user services 851, wherein user services are services which user willing to provide to other users including add or post structured fields and associate structured contents, real-time converse with prospective buyers, provide comparative analysis & similar products & services, provide answers, shared contextual contents, search results & like 851. User can set schedule 855 for providing one or more types of said selected services 851. Based on said selected user services preferences selected by user, other users of networks can ask for or request or access or use or subscribe said services of said user and system can enable appropriate features, applications, web services, databases, interfaces, controls, forms, web page, widgets for enabling user to provide said selected user services. User can add, select, update, view, share, organize, access & mange user profile, user account, payment details, preferences, privacy settings, history or logs or activities, points management, contacts, followers, viewers, statistics, user posts or shared content or structured fields and/or associate structured contents, followed posts or products or services or sources, sent or received messages, submitted requests, verification requests.

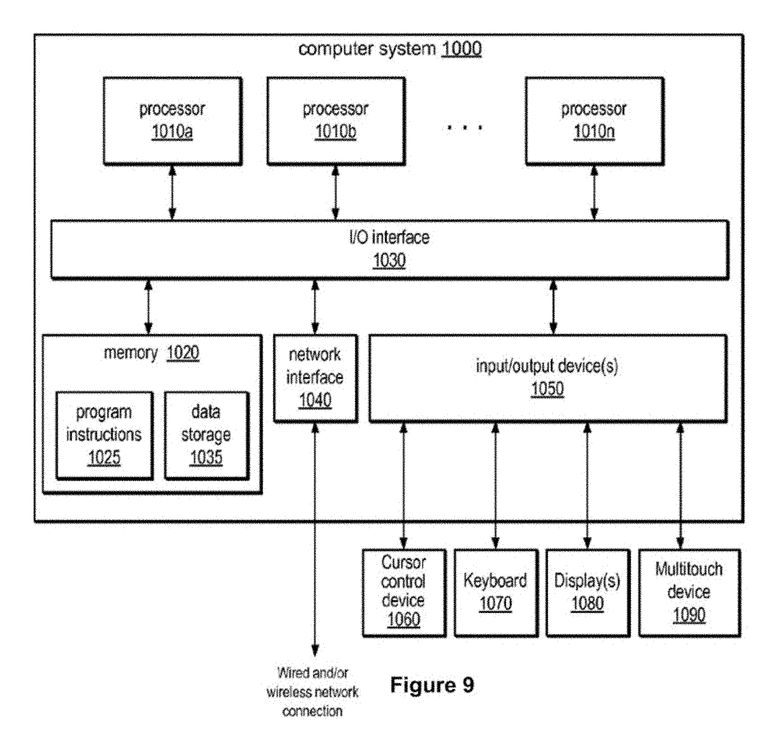

Various components of embodiments of methods as illustrated and described in the accompanying description may be executed on one or more computer systems, which may interact with various other devices. One such computer system is illustrated by FIG. 9. In different embodiments, computer system 1000 may be any of various types of devices, including, but not limited to, a personal computer system, desktop computer, laptop, notebook, or notebook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In the illustrated embodiment, computer system 1000 includes one or more processors 1010 coupled to a system memory 1020 via an input/output (I/O) interface 1030. Computer system 1000 further includes a network interface 1040 coupled to I/O interface 1030, and one or more input/output devices 1050, such as cursor control device 1060, keyboard 1070, multitouch device 1090, and display(s) 1080. In some embodiments, it is contemplated that embodiments may be implemented using a single instance of computer system 1000, while in other embodiments multiple such systems, or multiple nodes making up computer system 1000, may be configured to host different portions or instances of embodiments. For example, in one embodiment some elements may be implemented via one or more nodes of computer system 1000 that are distinct from those nodes implementing other elements.

In various embodiments, computer system 1000 may be a uniprocessor system including one processor 1010, or a multiprocessor system including several processors 1010 (e.g., two, four, eight, or another suitable number). Processors 1010 may be any suitable processor capable of executing instructions. For example, in various embodiments, processors 1010 may be general-purpose or embedded processors implementing any of a variety of instruction set architectures (ISAs), such as the x86, PowerPC, SPARC, or MIPS ISAs, or any other suitable ISA. In multiprocessor systems, each of processors 1010 may commonly, but not necessarily, implement the same ISA.

In some embodiments, at least one processor 1010 may be a graphics processing unit. A graphics processing unit or GPU may be considered a dedicated graphics-rendering device for a personal computer, workstation, game console or other computing or electronic device. Modern GPUs may be very efficient at manipulating and displaying computer graphics, and their highly parallel structure may make them more effective than typical CPUs for a range of complex graphical algorithms. For example, a graphics processor may implement a number of graphics primitive operations in a way that makes executing them much faster than drawing directly to the screen with a host central processing unit (CPU). In various embodiments, the methods as illustrated and described in the accompanying description may be implemented by program instructions configured for execution on one of, or parallel execution on two or more of, such GPUs. The GPU(s) may implement one or more application programmer interfaces (APIs) that permit programmers to invoke the functionality of the GPU(s). Suitable GPUs may be commercially available from vendors such as NVIDIA Corporation, ATI Technologies, and others.

System memory 1020 may be configured to store program instructions and/or data accessible by processor 1010. In various embodiments, system memory 1020 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing desired functions, such as those for methods as illustrated and described in the accompanying description, are shown stored within system memory 1020 as program instructions 1025 and data storage 1035, respectively. In other embodiments, program instructions and/or data may be received, sent or stored upon different types of computer-accessible media or on similar media separate from system memory 1020 or computer system 1000. Generally speaking, a computer-accessible medium may include storage media or memory media such as magnetic or optical media, e.g., disk or CD/DVD-ROM coupled to computer system 1000 via I/O interface 1030. Program instructions and data stored via a computer-accessible medium may be transmitted by transmission media or signals such as electrical, electromagnetic, or digital signals, which may be conveyed via a communication medium such as a network and/or a wireless link, such as may be implemented via network interface 1040.

In one embodiment, I/O interface 1030 may be configured to coordinate I/O traffic between processor 1010, system memory 1020, and any peripheral devices in the device, including network interface 1040 or other peripheral interfaces, such as input/output devices 1050. In some embodiments, I/O interface 1030 may perform any necessary protocol, timing or other data transformations to convert data signals from one component (e.g., system memory 1020) into a format suitable for use by another component (e.g., processor 1010). In some embodiments, I/O interface 1030 may include support for devices attached through various types of peripheral buses, such as a variant of the Peripheral Component Interconnect (PCI) bus standard or the Universal Serial Bus (USB) standard, for example. In some embodiments, the function of I/O interface 1030 may be split into two or more separate components, such as a north bridge and a south bridge, for example. In addition, in some embodiments some or all of the functionality of I/O interface 1030, such as an interface to system memory 1020, may be incorporated directly into processor 1010.

Network interface 1040 may be configured to allow data to be exchanged between computer system 1000 and other devices attached to a network, such as other computer systems, or between nodes of computer system 1000. In various embodiments, network interface 1040 may support communication via wired and/or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

Input/output devices 1050 may, in some embodiments, include one or more display terminals, keyboards, keypads, touchpads, scanning devices, voice or optical recognition devices, or any other devices suitable for entering or retrieving data by one or more computer system 1000. Multiple input/output devices 1050 may be present in computer system 1000 or may be distributed on various nodes of computer system 1000. In some embodiments, similar input/output devices may be separate from computer system 1000 and may interact with one or more nodes of computer system 1000 through a wired and/or wireless connection, such as over network interface 1040.

As shown in FIG. 9, memory 1020 may include program instructions 1025, configured to implement embodiments of methods as illustrated and described in the accompanying description, and data storage 1035, comprising various data accessible by program instructions 1025. In one embodiment, program instruction 1025 may include software elements of methods as illustrated and described in the accompanying description. Data storage 1035 may include data that may be used in embodiments. In other embodiments, other or different software elements and/or data may be included.

Those skilled in the art will appreciate that computer system 1000 is merely illustrative and is not intended to limit the scope of methods as illustrated and described in the accompanying description. In particular, the computer system and devices may include any combination of hardware or software that can perform the indicated functions, including computers, network devices, internet appliances, PDAs, wireless phones, pagers, etc. Computer system 1000 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Accordingly, the present invention may be practiced with other computer system configurations.

Various embodiments may further include receiving, sending or storing instructions and/or data implemented in accordance with the foregoing description upon a computer-accessible medium. Generally speaking, a computer-accessible medium may include storage media or memory media such as magnetic or optical media, e.g., disk or DVD/CD-ROM, volatile or non-volatile media such as RAM (e.g. SDRAM, DDR, RDRAM, SRAM, etc.), ROM, etc., as well as transmission media or signals such as electrical, electromagnetic, or digital signals, conveyed via a communication medium such as network and/or a wireless link.

The various methods as illustrated in the Figures and described herein represent examples of embodiments of methods. The methods may be implemented in software, hardware, or a combination thereof. The order of method may be changed, and various elements may be added, reordered, combined, omitted, modified, etc. Various modifications and changes may be made as would be obvious to a person skilled in the art having the benefit of this disclosure. It is intended that the invention embrace all such modifications and changes and, accordingly, the above description to be regarded in an illustrative rather than a restrictive sense.

In an embodiment a program is written as a series of human understandable computer instructions that can be read by a compiler and linker, and translated into machine code so that a computer can understand and run it. A program is a list of instructions written in a programming language that is used to control the behavior of a machine, often a computer (in this case it is known as a computer program). A programming language's surface form is known as its syntax. Most programming languages are purely textual; they use sequences of text including words, numbers, and punctuation, much like written natural languages. On the other hand, there are some programming languages which are more graphical in nature, using visual relationships between symbols to specify a program. In computer science, the syntax of a computer language is the set of rules that defines the combinations of symbols that are considered to be a correctly structured document or fragment in that language. This applies both to programming languages, where the document represents source code, and markup languages, where the document represents data. The syntax of a language defines its surface form. Text-based computer languages are based on sequences of characters, while visual programming languages are based on the spatial layout and connections between symbols (which may be textual or graphical or flowchart(s)). Documents that are syntactically invalid are said to have a syntax error. Syntax—the form—is contrasted with semantics—the meaning. In processing computer languages, semantic processing generally comes after syntactic processing, but in some cases semantic processing is necessary for complete syntactic analysis, and these are done together or concurrently. In a compiler, the syntactic analysis comprises the frontend, while semantic analysis comprises the backend (and middle end, if this phase is distinguished). There are millions of possible combinations, sequences, ordering, permutations & formations of inputs, interpretations, and outputs or outcomes of set of instructions of standardized or specialized or generalized or structured or functional or object oriented programming language(s).

The present invention has been described in particular detail with respect to a limited number of embodiments. Those of skill in the art will appreciate that the invention may additionally be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Furthermore, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component. Additionally, although the foregoing embodiments have been described in the context of a social network website, it will apparent to one of ordinary skill in the art that the invention may be used with any social network service, even if it is not provided through a website. Any system that provides social networking functionality can be used in accordance with the present invention even if it relies, for example, on e-mail, instant messaging or any other form of peer-to-peer communications, or any other technique for communicating between users. Systems used to provide social networking functionality include a distributed computing system, client-side code modules or plug-ins, client-server architecture, a peer-to peer communication system or other systems. The invention is thus not limited to any particular type of communication system, network, protocol, format or application.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

What is claimed is:

1. A server, comprising: a processor; and a memory storing instructions executed by the processor to: receiving one or more data field names, associate data type and data type specific value(s) related to particular identified or unique keyword(s); verifying said received data field(s), associate data type and value(s) related to identified or unique keyword(s); after verification, creating or adding said data field(s) related to particular data type in database; insert said each created data field name associate day type specific said provided value(s) to said created data field; receiving request(s) from one or more users of network to access and select said identified or unique keyword(s) specific created one or more data fields for providing associate data type specific value(s); enabling to select or presenting searched and matched or contextual one or more data fields for enabling user to provide selected field(s) related data type specific value(s); receiving and storing said field(s) related data type specific value(s) from one or more users of network; receiving request to search and access one or more keywords related data field(s) related data type specific value(s) provided by users of network; serving searched and matched data fields related data type specific values provided by users of network to searching or viewing users of network.

2. The serve of claim 1 wherein enabling searching or requesting user to access including view, search, match, select, share viewed or searched and matched data fields related data type specific values provided by users of network.

3. The serve of claim 1 wherein to enabling to access said searched and matched data fields related data type specific values related one or more types of user actions.

4. The server of claim 3, wherein user actions comprises download, buy, subscribe, refer, share, add to cart, make purchase enquiry, sent requirement specifications, request or ask for quote, make order, make payment, participate in group deals, book tickets, add to watch or wish list, sent messages to actual customers or sellers, register domains, update or upgrade products or services, sent job profile, invite users, book table, apply for credit card, listen music, view videos, ask for sample, provide contact details or permissions, bookmark or add to one or more types of lists, say buying interest, ask for discount or negotiate, provide bid, purchase based on reviews or comments or reviews or comments of particular user(s), register web site, ask for demonstration or presentation or site seeing & like.

5. The server of claim 1 wherein keywords, key phrases, categories, taxonomies, items, nodes, lists, named entities including products or services or brand name, web sites, applications, device, item, things, person, group, movie, music, book, shop, real estate, road, company or business names, locations or place, activities, actions, events, transactions.

6. The serve of claim 5 wherein verifying keywords, key phrases, categories, taxonomies, items, nodes, lists, named entities, structured fields or fields comprises spell or language checking, checking uniqueness, spam or duplicate or similar keywords, key phrases, categories, taxonomies, items, nodes, lists, named entities, structured fields or fields.

7. The server of claim 6, wherein verifying keywords, key phrases, categories, taxonomies, items, nodes, lists, named entities, structured fields or fields comprises verify via human(s) including administrator(s) and/or web sites or applications and/or service(s) and/or search engine(s) and/or database(s) including thesaurus or dictionaries.

8. The server of claim 1, wherein adding points to user account based on adding or updating structured fields, posting one or more types of contents or structured fields specific contents, number of posts, provided structured fields, views, provided or received views, likes or dis-likes, ratings, comments, reviews, reports, followers, viewers & contacts or connections, viewing advertised contents, purchasing of products, subscribing services, make payments, refer products or services, participate in activities, downloading applications, registering with web sites, taking one or more actions including providing contact details, detail profile, fill-up forms and like.

9. The server of claim 1, wherein deducting points to user account based on number of searches or browsing or viewing, number of times or duration of real-time communicating, collaborating & messaging with actual customers or experts, number of verifications of products or services or people based on number of structured fields, number of requested or requested types of contents including answers of questions, search results, media, directions, map, address, price, comparisons, availability, sources of purchases, suggestions or similar products or services or named entities.

10. The server of claim 1 wherein data type including text, flag, integer, numeric, date & time, currency, visual media including photo, video, voice & image, list (combo box, checkboxes or radio buttons for selection), ranges.

11. The server of claim 10, wherein enabling user to define validation logic of structured fields including flag & ranges, length of field, maximum or minimum values, selection from provided or defined list of values, measurements or type of currency including kilogram, inch, liter & dollar, select or associate one or more type of applications, interfaces, controls & forms including textbox or edit control, combo box, list box, checkbox, radio button, selections, menus, buttons including submit button for user selections & providing structured field specific structured contents.

12. An electronic device, comprising: providing one or more data field name(s), each data field associated or selected data type and each data field associated, selected or inputted data type specific value(s) related to particular identified or unique keyword(s); after verification and acceptance of said provided or submitted or suggested or posted one or more data field name(s) and associate value(s), allow users of network including said user to search, request, select and provide said verified particular identified or unique keyword(s) related data field(s) related value(s); send request to access or providing search query to search or select one or more identified or unique keyword(s) related data fields; view said requested or search query related one or more identified or unique keyword(s) related data fields; provide value(s) related to one or more identified or unique keyword(s) related selected data fields; send request to access or providing search query to search one or more identified or unique keyword(s) specific data fields related value(s); receive said request or search query specific data fields and/or related value(s).

13. The electronic device of claim 12 wherein enabling searching or requesting user to access including view, search, match, select, share viewed or searched and matched data fields related data type specific values provided by users of network.

14. The electronic device of claim 12 wherein to enabling to access said searched and matched data fields related data type specific values related one or more types of user actions.

15. The electronic device of claim 14, wherein user actions comprises download, buy, subscribe, refer, share, add to cart, make purchase enquiry, sent requirement specifications, request or ask for quote, make order, make payment, participate in group deals, book tickets, add to watch or wish list, sent messages to actual customers or sellers, register domains, update or upgrade products or services, sent job profile, invite users, book table, apply for credit card, listen music, view videos, ask for sample, provide contact details or permissions, bookmark or add to one or more types of lists, say buying interest, ask for discount or negotiate, provide bid, purchase based on reviews or comments or reviews or comments of particular user(s), register web site, ask for demonstration or presentation or site seeing & like.

16. The electronic device of claim 12 wherein data type including text, flag, integer, numeric, date & time, currency, visual media including photo, video, voice & image, list (combo box, checkboxes or radio buttons for selection), ranges.

17. The electronic device of claim 12, wherein enabling user to define validation logic of structured fields including flag & ranges, length of field, maximum or minimum values, selection from provided or defined list of values, measurements or type of currency including kilogram, inch, liter & dollar, select or associate one or more type of applications, interfaces, controls & forms including textbox or edit control, combo box, list box, checkbox, radio button, selections, menus, buttons including submit button for user selections & providing structured field specific structured contents.

18. The electronic device of claim 12 wherein keywords, key phrases, categories, taxonomies, items, nodes, lists, named entities including products or services or brand name, web sites, applications, device, item, things, person, group, movie, music, book, shop, real estate, road, company or business names, locations or place, activities, actions, events, transactions.
